(19) United States
(12) Patent Application Publication
(10) Pub. No.: US 2017/0016761 A1
(43) Pub. Date: Jan. 19, 2017

(54) A METHOD OF DETECTING A DEFECT LIGHT SENSOR

(71) Applicant: PHILIPS LIGHTING HOLDING B.V., Eindhoven (NL)

(72) Inventor: THEODORUS JACOBUS JOHANNES DENTENEER, EINDHOVEN (NL)

(73) Assignee: Philips Lighting Holding B.V.

(21) Appl. No.: 15/121,789

(22) PCT Filed: Feb. 16, 2015
(86) PCT No.: PCT/EP2015/053211

§ 371 Date: Aug. 26, 2016

(30) Foreign Application Priority Data
Feb. 26, 2014 (EP) 14156800.6

(51) Int. Cl. G01J 1/02; G01J 1/42

(52) U.S. Cl. CPC G01J 1/0228; G01J 1/4204

(57) ABSTRACT

A method of detecting a defect light sensor, includes the operations of:—collecting data, comprising collecting light sensor data;—performing a preparation procedure on the collected data in order to determine a template; and—performing a detection procedure for determining a light sensor status. The operation of performing a preparation procedure includes determining a template of the behavior of the light sensor data collected during a time period constituting a part of a day with well-defined conditions The operation of performing a detection procedure includes the operations of:—collecting light sensor data for several further days during the corresponding time period;—selecting representative days thereof;—determining a corresponding behavior for each selected day; and—comparing the corresponding behavior with the template to detect any defect of the light sensor.

### FIELD OF THE INVENTION

The present invention relates to a method of detecting a defect light sensor.

### BACKGROUND OF THE INVENTION

Luminaires are being wirelessly connected and integrated into lighting systems. Combined with light sensors, and possibly other sensors like PIR sensors, these lighting systems are designed to provide advanced functions like daylight adaptation for energy saving. However, proper functioning of the lighting system depends on the correct functioning and calibration of the sensors. It is known that these may degrade and drift over time. Hence, proper calibration techniques must be employed to detect the behaviour of the sensors, so that recalibration or replacement can occur when sensor faults are detected.

Current detection of defect light sensors is done in active ways, typically including manual or programmed switching on and off of the lighting system, and/or the use of a particular calibrated light source and/or reference light sensor. Therefore, the current detection methods require a substantial addition of system modes and control code.

### SUMMARY OF THE INVENTION

It would be advantageous to simplify the detection of a defect light sensor.

To better address this concern, in a first aspect of the invention there is presented a method of detecting a defect light sensor, comprising:

collecting data, comprising collecting light sensor data;

performing a preparation procedure on the collected data in order to determine a template; and

performing a detection procedure for determining a light sensor status;

said performing a preparation procedure comprising:

determining a template of the behavior of the light sensor data collected during a time period constituting a part of a day with well-defined conditions; and

said performing a detection procedure comprising:

collecting light sensor data for several further days during the corresponding time period;

selecting representative days thereof;

determining a corresponding behavior for each selected day; and

comparing the corresponding behavior with the template to detect any defect of the light sensor.

Thus, the present method relies on more passively recording sensor information from the lighting system. By selecting data which has been collected during similar or comparable circumstances, it is possible to compare the data and discover defect behaviour of the light sensor.

In accordance with an embodiment of the method, the time period is at night. This is advantageous in that light from other sources than the lighting system which the light sensor refers to are either negligible or relatively constant.

In accordance with an embodiment of the method, the collection of data further comprises collecting outdoor weather data in conjunction with said light sensor data, and wherein the determination of a template behavior of the light data comprises determining a template of a relation between the light sensor data and the outdoor weather data collected during said time period. Furthermore, the operation of performing a detection procedure comprises collecting outdoor weather data in conjunction with said light sensor data, the operation of determining a corresponding behavior comprises determining a corresponding relation for each selected day, and the operation of comparing the corresponding behavior with the template comprises comparing the relations with the template to detect any defect of the light sensor. It is advantageous to consider also outdoor weather data, and to relate the light sensor data to that data.

In accordance with an embodiment of the method the light sensor data is indoor light sensor data, and the operation of determining a template of a relation comprises:

selecting a model sequence of outdoor weather data collected during said time period;

selecting further sequences of outdoor weather data for the corresponding time period of other days, where the outdoor weather data is within predetermined limits of the model sequence data;

for each selected sequence of outdoor weather data, determining whether the corresponding indoor light sensor data has been collected during said well-defined indoor conditions, and if so, then determining said relation.

In accordance with an embodiment of the method the operation of determining a template of a relation comprises:

determining a coefficient representing each relation; and

determining statistical values for the coefficients, which statistical values constitute said template.

In accordance with an embodiment of the method the operation of determining a coefficient comprises fitting a linear dependence of the indoor light sensor data on the outdoor weather data.

In accordance with an embodiment of the method the operation of comparing the set of coefficients with the template comprising displaying the coefficients in a control chart and applying one or more of the Nelson rules to the set of coefficients and said template.

In accordance with an embodiment of the method, it comprises determining said well-defined indoor conditions by means of presence data.

In accordance with an embodiment of the method, it comprises determining said well-defined indoor conditions by means of at least one type of data out of a set of data consisting of data on window blinds, data on switching or dimming status of a lighting system, or data on energy consumption by a lighting system.

In accordance with an embodiment of the method the operation of selecting further sequences comprising determining if the outdoor weather data is within predetermined limits of the model sequence data by applying a distance function to the outdoor weather data and the model sequence data.

In accordance with an embodiment of the method the weather data comprises solar irradiation data.

### BRIEF DESCRIPTION OF THE DRAWINGS

The invention will now be described in more detail and with reference to the appended drawings in which:

FIG. 1 is a block diagram of an example system for performing the present method;

FIGS. 2 to 5 are diagrams showing indoor light sensor data versus outdoor weather data for different ranges of time;

FIGS. 6 and 7 are diagrams showing selected data from FIG. 2 illustrated by curves connecting the data points;

FIG. 8 is a flow chart illustrating a preparation procedure according to an embodiment of the present method;

FIG. 9 is a flow chart illustrating a detection procedure according to an embodiment of the present method;

FIG. 10 is a chart illustrating one way of determining a defect;

FIGS. 11 and 12 are flow charts illustrating procedures according to another embodiment of the method; and

FIGS. 13 and 14 are diagrams showing results obtained by an embodiment of the method.

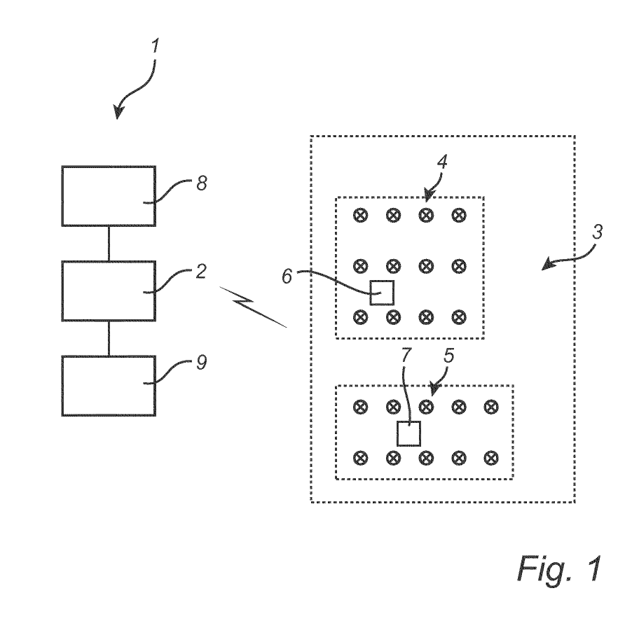

### DESCRIPTION OF EMBODIMENTS

An example monitoring system 1 in which the present method of detecting a defect light sensor is implementable comprises a controller 2 connected, wireless or by wire, to a lighting system 3 having several sets of luminaires 4, 5 arranged in different rooms of a building. More particularly, the controller 2 is connected with an indoor light sensor 6, 7, or with several indoor light sensors, in each of the rooms, detecting indoor illumination. The monitoring system 1 further comprises an outdoor weather sensor 8, arranged outdoor of the building. The outdoor weather sensor 8 typically is also a light sensor detecting outdoor illumination. The controller 2 is connected to a display 9. As understood from the above, the monitoring system 1 can be connected to several light sensors 6, 7, which can be arranged in one or more lighting systems 3. However, if nothing else is expressed below, the description refers to a single light sensor, but is equally valid for every light sensor 6, 7 when the monitoring system 1 is connected with several light sensors 6, 7.

Generally, the method according to the present invention can be regarded as being based on a passive recording of sensor data, and processing of the data in order to find a diverging behavior of a light sensor. This is in contrast to prior art methods where the luminaires are actively operated in conjunction with the data recording. According to a first embodiment of the method, indoor light sensor data and outdoor weather data, in this embodiment being light sensor data as well, is collected by means of the indoor light sensors 6, 7 and the outdoor weather sensor 8. The data collection is performed for several days during at least a part of each day. Then a preparation procedure on the collected data is performed in order to determine a template, which represents the behavior of a fully functioning light sensor. In order to enable the calculation of a reliable and useful template, the conditions when data are collected must be stable and repeatable. Hence, the preparation procedure involves determining, by means of the controller 2, a template of a relation between the indoor light sensor data and the outdoor weather data collected during a time period constituting a part of the day with well-defined indoor and outdoor conditions.

Having determined the template, then a detection procedure for determining the status of the light sensors 6, 7 is performed, separately for each light sensor 6, 7. In general terms, the detection procedure comprises using the controller 2 for collecting outdoor weather data, from the weather sensor 8, and indoor light sensor data, from the light sensor 6, 7, for several further days during the corresponding time period; selecting representative days thereof; determining a corresponding relation for each selected day; and comparing the relations with the template to detect any defect of the light sensor 6, 7.

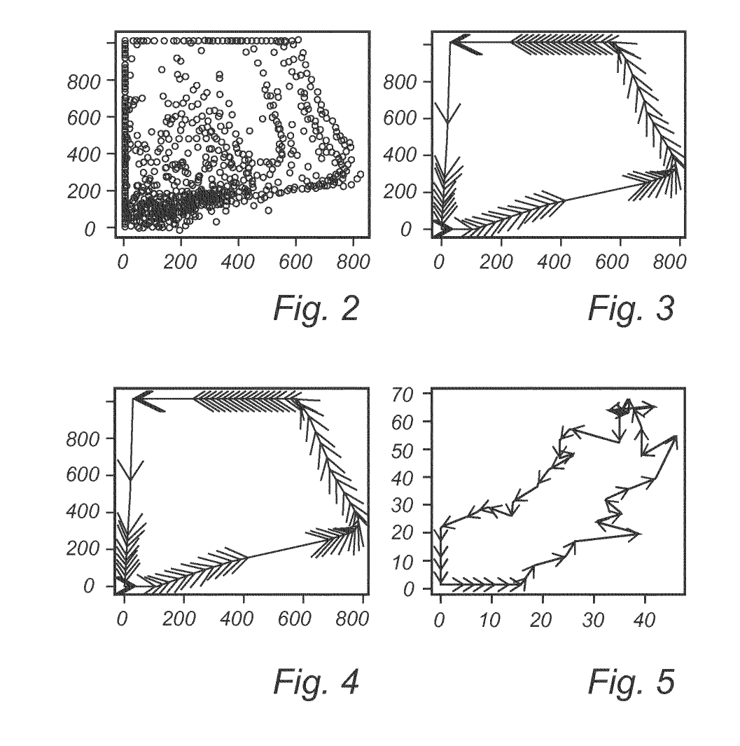

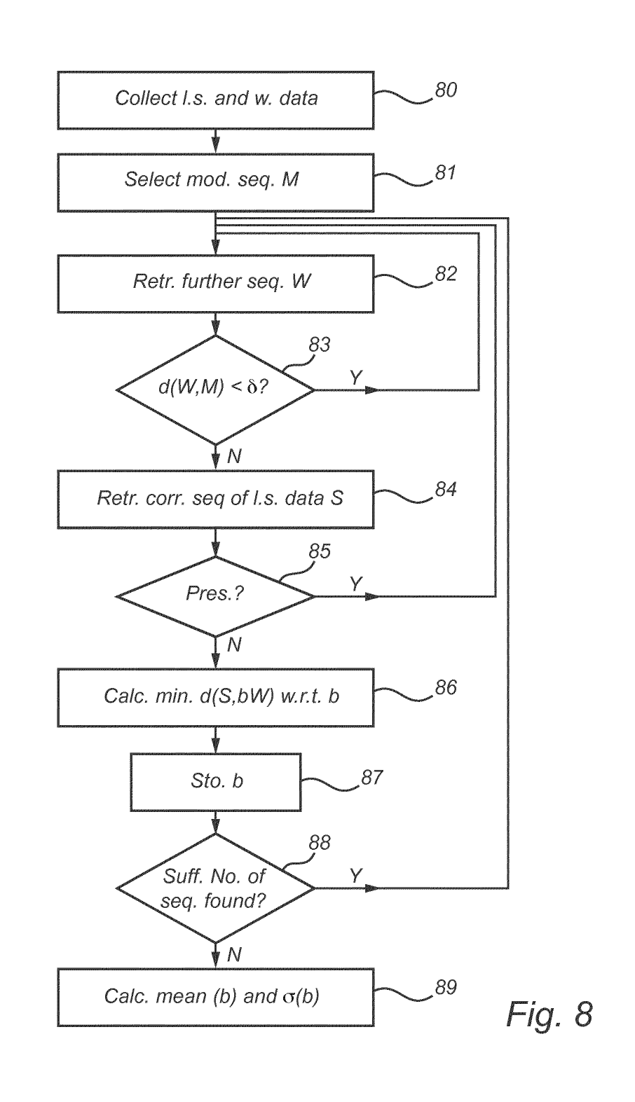

More particularly, as illustrated by the flow chart of FIG. 8, according to this embodiment, the preparation procedure comprises collecting light sensor data and weather data for several consecutive days, all day around, see box 80. For instance the sensor outputs are sampled every 5-10 minutes. FIG. 2 shows samples taken during the first half of a year, and are presented as the dependence of the indoor light sensor data on the outdoor weather data, such that the y-axis denotes indoor light levels and the x-axis denotes outdoor light levels. The illumination within a room varies with outdoor illumination, and this dependence is used as a basis for detecting light sensor defects. For a linear dependence, or high correlation, between the indoor light level and the outdoor light level, the pairs should be on a straight line. However, as can be seen in FIG. 2, the pairs are far from concentrated on a straight line and, in fact, the overall correlation is only about 0.3.

Thus, the dependence is of a more complicated nature, which is caused by a number of environmental conditions. Firstly, occupants of the building will interfere with the indoor light levels as derived from the outdoor light levels in a number of ways. They may interfere directly by opening or closing blinds and switching luminaires on and off. Secondly, for instance, even by moving around, or moving the papers on a desk, reflections can considerably change the measured illumination levels in a room. Additionally, the room orientation and the shading have significant influence. In the present example, to observe the dependence in a more unperturbed manner, data from weekends was selected. Plots of the indoor light sensor data versus the outdoor weather data are shown in FIGS. 3 to 5 for three different days on weekends. FIG. 3 shows a day at the end of April, FIG. 4 shows the following day, and FIG. 5 shows a day at the beginning of January. In addition to the plot, successive observations have been interconnected by means of a directed line. Thus, arrows indicate the temporal behavior of the observations. The observation starts in the lower left corner of the plot, where it was dark both outdoor and indoor in the beginning of the day. Subsequently, both outdoor and indoor light levels rise and decay. It can be seen from FIG. 3 that there is a functional dependence of indoor light level on outdoor light level, which is distinctly non-linear throughout the day, and depends on the angle with which the sunlight enters the room. From FIG. 4, it can be concluded that this dependence is more or less deterministic. Indeed, the same trajectory is observed on a similar day in conditions that can be assumed to be similar. Finally FIG. 5 illustrates the dependence on season. Again, the data reveal a clear, be it non-linear, dependence on a day on which there was no presence in the building. However, the shape of the trajectory is different, and, as outdoor light levels are low in January relative to April, only a small part of the illumination space is traversed. As an explanation of the look of the graph in FIG. 3, it can be mentioned that the sharp turn at the lower right corner, at A, represents the sun light starting to enter the room; and the sharp turn to the upper left, at B, represents the sun being hidden behind a building.

In conclusion, it can be observed that a strong functional dependence exists between indoor and outdoor illumination levels during well-defined indoor and outdoor conditions. This dependence can in principle be exploited for various purposes. The above mentioned template of the relation, i.e. said functional dependence, between indoor light sensor data and outdoor weather data can be determined as follows. From FIGS. 3 and 4 it is evident that a strong linear correlation exists between indoor and outdoor light levels during early bright mornings in the weekends, and such correlations can be exploited for light sensor diagnosis. Thus, first a model sequence of outdoor weather data collected during a time period constituting a suitable part of the day is selected, see box 81. In this example the weather data for the first two and a half hours of one of the shown April days is selected as the model sequence.

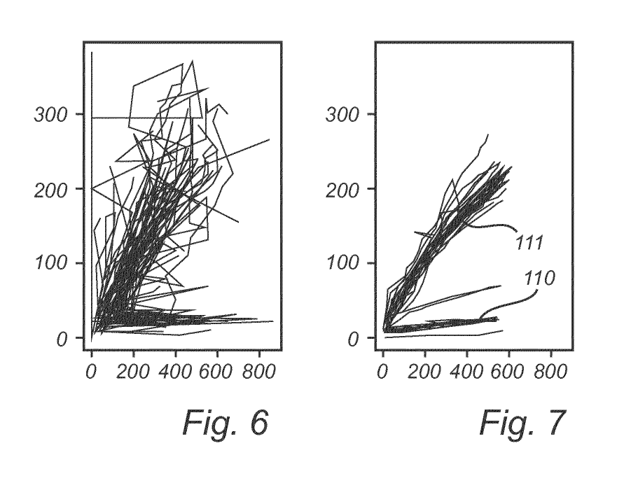

Then further sequences W of outdoor weather data for the corresponding time period of other days are retrieved, one at a time, box 82, and tested against the model sequence M, by means of a distance function d(M, W)<δ, box 83. If the distance is too large, then a next sequence is tested. Those sequences W falling within predetermined limits, determined by choosing the size of δ, of the model sequence data M are selected. FIGS. 6 and 7 illustrate this selection, where the curves of FIG. 6 represent the data collected all days during the selected time period. The curves of FIG. 7 represent the curves remaining after having applied the distance function on the weather data and the selection on basis of presence. It is noticeable that there are two distinctly different sets of linear curves, a first set 110 having but a small slope, and a second set 111 having a significant slope. Here a third criteria will have to be applied, since the first set results from data collected with the blinds closed at the windows of the room, while the second set results from data collected with the blinds open.

For each selected sequence W of outdoor weather data, the corresponding indoor light sensor data S are retrieved, box 84. It is determined whether or not the indoor light sensor data S has been collected during well-defined indoor conditions, box 85, which in this embodiment is performed by determining whether or not someone has been present in the room during the collection of the data. If no one has been present the light sensor data S is accepted. Presence data can be obtained in different ways. In an office presence data is typically available from the enterprise using the office. As an alternative, a particular presence sensor can be added to the monitoring system 1. Then the relation between the indoor light sensor data and the outdoor weather data is determined, by determining a coefficient b representing the relation, and more particularly b is calculated such that the distance d(S, bW) is minimized, box 86. In other words, the determination of the coefficient consists of fitting a linear dependence of the indoor light sensor data S on the outdoor weather data W. The coefficients b for several selected sequences of light sensor data are stored, box 87, and then it is determined whether or not a sufficient number of selected sequences of light sensor data, and thus corresponding coefficients b, have been found, box 88. Finally, in box 89, as a last operation of the preparation procedure, statistical values for the stored coefficients b are determined. The statistical values constitute said template. According to this embodiment of the method, the statistical values are the mean and the standard deviation of b, i.e. mean (b) and σ (b).

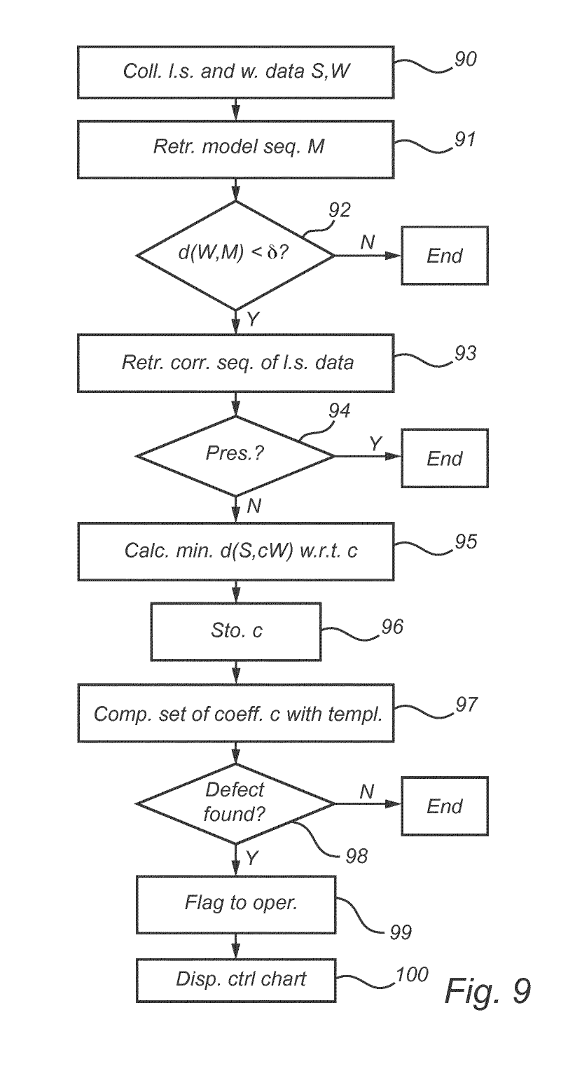

Having thus determined a template, the continuous monitoring, i.e. the detection procedure, is begun. The detection procedure according to the first embodiment of the method, is illustrated with the flow chart of FIG. 9. In short the detection procedure involves the operations of collecting outdoor weather data and indoor light sensor data for several further days during the corresponding time period; selecting representative days thereof; determining a corresponding relation for each selected day; and comparing the relations with the template to detect any defect of the light sensor.

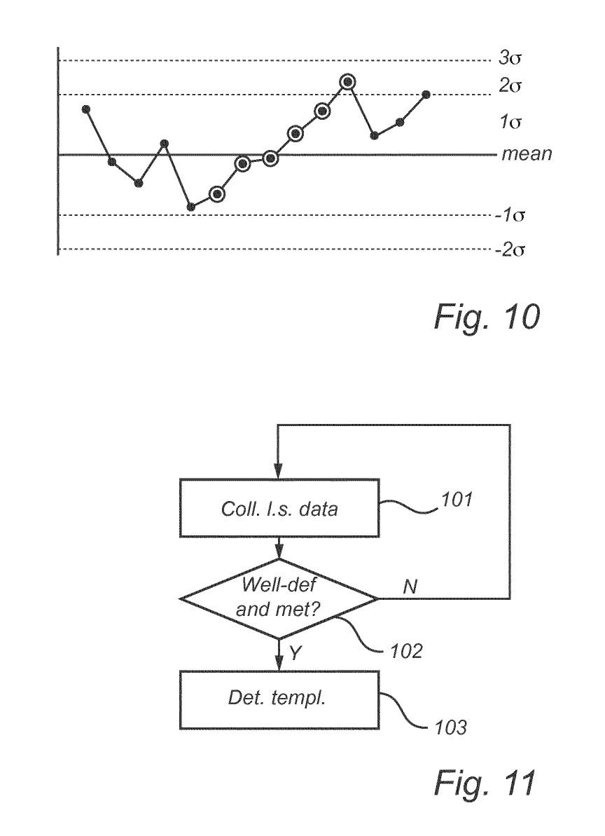

More particularly, each new day, light sensor data and weather data are selected during the time period, i.e. during the two and a half hours in the morning, box 90. Then the model sequence M is retrieved, box 91, and it is determined if the weather data is within predetermined limits of the model sequence, i.e. if the distance between the sequence of weather data W and the model sequence M is smaller than the predetermined limit value δ, expressed by d(W, M)<δ, box 92. This is similar to the determination done in the preparation procedure described above. If the test is passed, then the light sensor data corresponding to the passed weather data is retrieved, box 93, and it is determined whether or not the light sensor data has been collected during the well-defined indoor conditions, i.e. during non-presence of people in the room, box 94, also similar to the preparation procedure. If not then the data of this day is rejected. If the test is passed, then the light sensor data S and the weather data W for that specific day are selected. Next, similar to the preparation procedure, a relation between the light sensor data S and the weather data W is determined by fitting a linear dependence of the light sensor data S on the weather data W, i.e. by calculating a coefficient c such that d(S, cW) is minimized, box 95. The coefficient c is stored in a database, box 96. Thus, after a while the database will hold a set of coefficients c for several days, for which the criteria for the selection have been met. Then the set of coefficients c is compared with the template, i.e. mean (b) and σ (b), and appropriate quality measures for determining deviations beyond what is considered as normal behavior of the light sensor are applied, box 97. As an example one or more of the so called Nelson rules can be applied as quality measures. The mean value and the standard deviation of the template constitute a basis of a chart where the following coefficients c are added. For instance, a trend among the values can be detected as illustrated in FIG. 10. One rule for defining a trend can be that the value of more than six coefficients in a row increase or decrease. For the light sensor such a trend can mean a defect. As a further example of a rule, a value that falls outside an interval defined by a mean value plus or minus three standard deviations is indicative of a defect sensor.

If a defect is discovered a flag is raised to an operator, boxes 98 and 99, and the control chart is displayed on the display 9, box 100. Alternatively, the very determination of whether there is a defect or not is made manually. Then the control chart is displayed and the operator looks for patterns that can indicate a defect. According to a second embodiment of the method, as illustrated by the flow chart of FIG. 11, the method is performed at night when there is no daylight to consider. The template then consists of the direct light sensor values, instead of the above described relation. Thus, for instance, a template is generated with light sensor data for well-defined conditions which, in addition to the night time of the day include non-presence and data defining whether the luminaires contributing to the illumination sensed by the light sensor are on or off.

More particularly, the preparation procedure comprises collecting light sensor data during a time period constituting a part of the night, as shown in box 101; determining whether or not the well-defined conditions are met, box 102. If not, new data is collected next night. If the conditions are met, a template of the behavior of the light sensor data is determined, box 103.

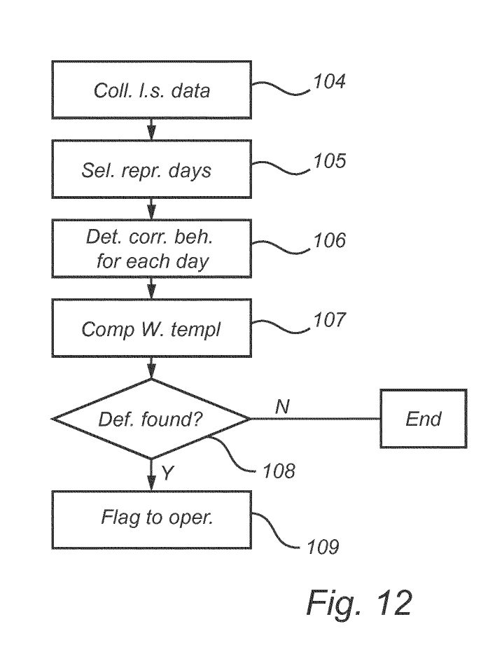

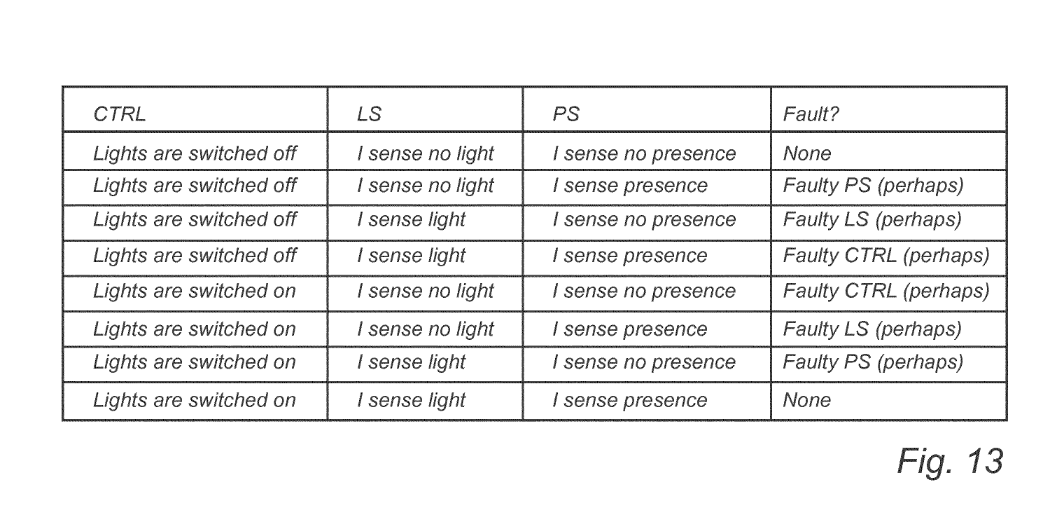

The detection procedure comprises collecting light sensor data for several further days during the corresponding time period, as shown in FIG. 12, box 104. Then representative days thereof are selected, box 105. The selection is done by identifying similar well-defined conditions. A corresponding behavior is determined for each selected day, box 106; and the corresponding behavior is compared with the template to detect any defect of the light sensor, box 107. If a defect is found, box 108, this is flagged to the operator, box 109. Alternatively, the final defect detection can be made manually by displaying the template and the light sensor data in a chart.

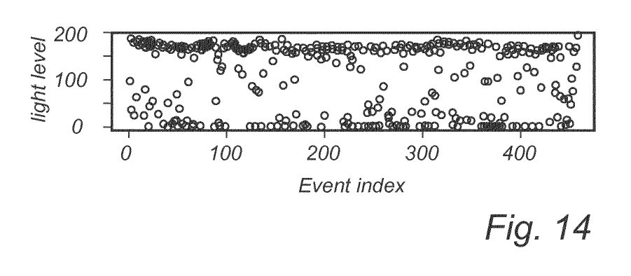

An example of collected light sensor values ranging over several nights is shown in FIG. 14, displayed by light level (y axis) versus a sequential number of the collected light sensor sample. There are two distinct light levels, which represent lights switched on and lights switched off. The intermediate light levels stems from the averaging behavior of a light sensor, and correspond to time slot during which a switch between on and off occurred, so that the environment was respectively dark and illuminated for only part of the time slot.

Further, a similar embodiment consists of making the operations for detecting a defect for one day at a time, such as continuously once a day. Then the operation of selecting representative days is exchange for determining whether the current day is a representative day. If not the procedure is ended there.

For the above embodiments of the method, further input data for determining well-defined indoor conditions may include data on window blinds, data on switching or dimming status of the lighting system, or data on energy consumption by the lighting system. Furthermore, additional determinations are possible to perform on basis of the further information obtained by such further input data.

It should be noted that the method can be performed both indoor and in other environments, as long as repeatable well-defined conditions can be established.

While the invention has been illustrated and described in detail in the drawings and foregoing description, such illustration and description are to be considered illustrative or exemplary and not restrictive; the invention is not limited to the disclosed embodiments.

For instance, other relations than linear can be determined for the coefficients. Another part of the day, such as the night or a part thereof can be chosen for determining the function of the light sensors, etc.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A method of detecting a defect light sensor, comprising:
collecting data, comprising collecting indoor light sensor data, and outdoor weather data in conjunction with said light sensor data;
performing a preparation procedure on the collected data in order to determine a template; and
performing a detection procedure for determining a light sensor status;
said performing a preparation procedure comprising:
determining a template representing the behavior of the light sensor data collected during a time period constituting a part of a day with well-defined conditions determined based on further input data; and
said performing a detection procedure comprising:
collecting light sensor data for several further days during the corresponding time period;
selecting representative days thereof by identifying similar well-defined conditions;
determining a corresponding behavior for each selected day; and
comparing the corresponding behavior with the template to detect any defect of the light sensor,
said determining a template behavior of the light data comprising:
determining a template of a relation between the light sensor data and the outdoor weather data collected during said time period;
said determining a template of a relation comprising:
selecting a model sequence of outdoor weather data collected during said time period;
selecting further sequences of outdoor weather data for the corresponding time period of other days, where the outdoor weather data is within predetermined limits of the model sequence data;
for each selected sequence of outdoor weather data, determining whether or not the corresponding indoor light sensor data has been collected during well-defined indoor conditions, and if so, determining said relation.

2. The method according to claim 1, wherein said time period is at night.

3. The method according to claim 1 comprising determining said well-defined conditions by means of presence data and data about whether luminaires are on or off.

4. The method according to claim 1,
said performing a detection procedure further comprising:
collecting outdoor weather data in conjunction with said light sensor data;
said determining a corresponding behavior comprising determining a corresponding relation for each selected day; and
said comparing the corresponding behavior with the template comprising comparing the relations with the template to detect any defect of the light sensor.

5. (canceled)

6. The method according to claim 4, said determining a template of a relation comprising:
determining a coefficient representing each relation; and
determining statistical values for the coefficients, which statistical values constitute said template.

7. The method according to claim 6, said determining a coefficient comprising fitting a linear dependence of the indoor light sensor data on the outdoor weather data.

8. The method according to claim 4, said selecting representative days thereof comprising:
for each day of said several further days, determining if the outdoor weather data is within predetermined limits of the model sequence, and if so, determining if indoor light sensor data has been collected during the well-defined indoor conditions, and if so select that day;
said determining a corresponding relation for each selected day comprising fitting a relation between the indoor light sensor data and the outdoor weather data;
determining a coefficient representing the relation; and
generating a set of coefficients comprising the determined coefficient and previously determined coefficients;
said comparing the relations with the template comprising comparing the set of coefficients with the template.

9. The method according to claim 8, said comparing the set of coefficients with the template comprising displaying the coefficients in a control chart and applying one or more of the Nelson rules to the set of coefficients and said template.

10. The method according to claim 4, comprising determining said well-defined conditions by means of presence data.

11. The method according to claim 4, comprising determining said well-defined indoor conditions by means of at least one type of data out of a set of data consisting of data on window blinds, data on switching or dimming status of a lighting system, or data on energy consumption by a lighting system.

12. The method according to claim 4, said selecting further sequences comprising determining if the outdoor weather data is within predetermined limits of the model sequence data by applying a distance function to the outdoor weather data and the model sequence data.

13. The method according to claim 4, wherein the weather data comprises solar irradiation data.
